(19) United States
(12) Patent Application Publication
(10) Pub. No.: US 2014/0074617 A1
(43) Pub. Date: Mar. 13, 2014

(54) Business Applications Using Social Media with Mobile Technology

(71) Applicants: Ashish Kumar Mukherji, Sunnyvale, CA (US); R K Chaitanya Balusu, North Potomac, MD (US); Prakash Krishnamoorthy Narayan, Fremont, CA (US)

(72) Inventors: Ashish Kumar Mukherji, Sunnyvale, CA (US); R K Chaitanya Balusu, North Potomac, MD (US); Prakash Krishnamoorthy Narayan, Fremont, CA (US)

(21) Appl. No.: 14/027,009

(22) Filed: Sep. 13, 2013

Related U.S. Application Data
(60) Provisional application No. 61/700,733, filed on Sep. 13, 2012.

(51) Int. Cl. G06Q 30/02

(52) U.S. Cl. CPC G06Q 30/0281; G06Q 30/0267
USPC 705/14.64; 705/346

(57) ABSTRACT

A business method is provided on a secure web service by a vendor for a client to develop a business application(s). The vendor provides a wireless access point at the client site for disseminating business application(s) to consumers over mobile devices when the mobile devices connect to a wireless or a cellular network using the wireless access point provided at the client site. The business application is received by the consumers after providing a feedback to a consumer survey that generates a consumer profile by gathering consumers' anonymized demographic, socio-economic, age, gender, preferences, and social networking information. The business method provides additional premium services to the client that includes providing consumer satisfaction information and analytics using consumer profile information generated from feedback and consumer satisfaction information. The analytics are used for creating customized business application(s) to provide target advertisement and promotion incentive to the consumers.

### CROSS REFERENCE TO RELATED APPLICATIONS

This application claims priority benefit from the Provisional Application No. 61/700,733, filed on Sep. 13, 2012, in the United States Patent and Trademark Office.

### BACKGROUND OF THE INVENTION

1. Field of the Invention

This invention is related to a business method and in particular, to a business method that offers a business owner a platform to develop business applications to manage customer relationship and to obtain business intelligence for providing customized advertising and promotional incentives directly to consumers on their mobile devices using a wireless gateway to connect to a wide area network (WAN) or cellular network over a wireless communication link. The business method further offers the business owner additional premium services to control and manage the business applications.

2. Description of the Related Art

Business application or a software business application (App) is a software instrument that resides on a consumer's device that includes stationary devices (such as a laptop computer, notebook, etc.) or mobile devices (for example, smart phones, tablets, and other mobile devices with connectivity to the internet, or to a cellular network etc.), that can communicate with a service provider using wireless gateways (hot spots) over a wireless communication link. Software business applications (or Apps) are widely used by consumers to access information, provide geographic location, and engage in commercial activities just to name a few, in cyber as well as physical space.

For a business owner to offer better products and services to consumers, it is extremely important to understand consumer profile for better customer relations management (CMR) and developing business intelligence (BI). For example, an Internet based business owner, may get access to consumers' socio-economic and demographic information for example, ethnicity, gender, age group, frequently-visited location(s) both in physical and cyber space, personal interest and shopping preferences from consumers' social media websites. More specifically, a business owner doing business on the Internet may own or rent a server to create and provide business application(s) to consumers through a secure web service to provide access to their special offers when consumers log-in to a social networking sites such as Facebook, Twitter, Google +, etc. using a third party server.

In return, the business owner may get access to consumer profile for example, consumers' socio-economic and demographic information that includes but is not limited to, ethnicity, gender, age group, frequently-visited location(s) both in physical and cyber space, personal interest and shopping preferences. In addition, most business owners would like to collect consumers' feedback and use that data for the purpose of analytics in order to customize and expand services to targeted groups based on socio-economic and demographic information. However, it is not very straight forward to access consumer profile from consumers walking in to a store front (walk-in consumer). A business owner would prefer to have access to consumer profile for their walk-in consumers as well.

Many consumer activities such as, locating businesses of interest for commercial activities, sharing information about preferences, feedback etc. that are based on their geographic location, has one important component namely a position locator application. There are several prior art patents that describe applications that are specific to position locator that may be used for locating a mobile device within a geographic region. For example, in the U.S. Pat. No. 7,848,765 issued on Dec. 7, 2010, to Phillips et al., a method for providing location based services is described. More specifically, location based services described therein includes services such as social networking, demographic information, tracking mobile devices, providing business information, and an adaptable user interface. A mobile user may also output location based information effecting a change on a portable device, providing a geofence, information and alerts, just to name a few.

A more sophisticated multi-tier geofencing method is described in the U.S. Pat. No. 8,504,061 issued on Aug. 6, 2013 to Grainger et al. In this patent a method and program products for geofence detection is disclosed where a mobile device is configured to perform a task when it enters a particular geographic region. The mobile device monitors a current location using coarse location parameters and transfers the location monitoring to subsystems upon entering a cell that intersects with the geographic region of interest. More importantly, the mobile device location is tracked using data gathered from the mobile device using methods such as, triangulation or using data from position sensor for example a Global Position Sensor (GPS) built into the mobile device. Once a mobile device is detected in a geographic location, the mobile device can receive data from the Internet or cellular network including that from a local business owner upon request from the mobile device owner using wireless connectivity (if available). It is noted that in accessing data from a business owner, the mobile device does not necessarily connects using a wireless access point located at the business owner's site.

A business application that supports location detection requires access to a large database and communication infrastructure so as to track a mobile device. While a large business owner for example, a national chain of department stores, may be able to support the cost of infrastructure and trained personnel to operate and maintain a large scale database and services, the cost is prohibitive for a small business owner. Business applications are offered by other service providers either through the Internet or cellular network. While some service providers offer flexibility to business owners to customize Apps, it is not always possible for a small business owner having limited resources and expertise to alter, redesign, and customize an App in response to consumer feedback, sometimes in a very short time to boost the business.

A business owner and in particular, a business owner having no access to a network or the Internet, or a small business owner for example, a local retail or a small neighborhood store, a restaurant, gas station, car wash, small garage or workshop, convenience store, drycleaners, a specialized cards and/or gift shop, a theatre or play house, bar/sports bar, just to name a few, localized in small geographic regions, would prefer to know their consumers' and particularly walk-in consumers' demographic and socio-economic profiles. Furthermore, a business owner would like to have the ability to analyze consumer profile information in order to offer customize services that may include but is not limited to, advertisements, incentives, special offers and/or discounts particularly targeted towards one or more consumer group(s). A business owner may like to disseminate special incentives to consumers and particularly, to walk-in consumers within a certain geographic region of the business location on and be able to customized those services within a short turn-around time or in real time, while a consumer is still in the vicinity of the business place on consumers' mobile devices using wireless communication link.

In this invention, a location based business method is provided. In one aspect of the invention a business owner provides a consumer with a business application(s) on consumer's mobile device, when the consumer enters a specific geographic region in the vicinity of the business location and connects to a wireless or a cellular network using a wireless gateway (hot-spot) configured at the business location. The business method allows the business owner to collect consumers' feedback that in turn generates, anonymized (without including personal information) consumer profile including demographic and socio-economic information, and provides a flexible platform to develop, design, control, monitor and customize the business application(s) in a short turn-around time or in real time.

### SUMMARY OF THE INVENTION

A business method is provided for a business owner (client) to create and disseminate business application(s) to consumer on a mobile device. In one embodiment of the invention a client provides the business application(s) when a consumer's mobile device connects to a wireless or a cellular network using a wireless access point or a wireless gateway located at the business site.

In one aspect of the invention, the business application(s) is provided to the consumer's mobile device via a web browser or by downloading an App, or a combination thereof, subjected to the consumer providing online, a feedback to a consumer survey. In one embodiment, feedback is provided by logging in to the consumer's social network site.

In one embodiment of the invention a service provider (vendor) provides a client a secure access over a wired or preferably, a wireless network to a remote server. The vendor provides a web service platform to the client through the secure access for business development and in particular, for creating and disseminating business application(s) that may include but is not limited to, receiving a feedback, performing data analysis (analytics), advertisements, promotion incentives such as special offers and store discounts, online auctions.

In one aspect of invention the vendor web service platform provides software tools to develop business application(s). The vendor web service includes but is not limited to, predetermined design templates for designing business application. In a different aspect, the client may use the software tools provided by the vendor to develop own design templates for creating business application(s). Advantageously, the client retains complete control over the design and development of the business application(s) including appearance and terms of disseminating the business application(s) to consumers.

In yet another aspect, the vendor provides necessary infrastructure and services to the client to set up a wireless access point at the client site for providing a wireless gateway for consumers to connect to the vendor server, a Wide Area Network (WAN) or to the Internet. In one embodiment, the wireless gateway includes a wireless router which is a captive web service enabled router to provide a Digital Subscriber Line (DSL) connection. In another embodiment, the wireless gateway includes a wireless router that is not a captive web service enabled device. The network connection is provided with a software enabled captive web service that can access a cellular network such as a 3G or 4G cellular network.

In another embodiment of the invention the vendor provides premium services including but not limited to data analysis (analytics) performed on consumers' profile including demographic and socio-economic information, frequency of usage of the business application(s) by consumers, consumer satisfaction feedback on a web service provided by the vendor. In one aspect of the invention, the client may compare analytics from a past or current usage of any business application(s) and apply it to design future business application(s) targeting a particular set or sub-set of current consumers.

### BRIEF DESCRIPTION OF THE DRAWINGS

Different aspects of the invention will be described using illustrations and flow charts shown in accompanying drawing figures in which:

FIG. 1 represents a schematic of a network infrastructure where the invention may be practiced;

FIG. 2 shows a flow chart outlining steps for a client to register with a vendor site;

FIG. 3 shows a view of a sample screen of a web service provided to a client to register with the vendor;

FIG. 4 represents an exemplary screen of a web service provided for signing-in using an Authorization Code;

FIG. 5 shows an exemplary web service layout provided for designing a business tool;

FIG. 6 shows an exemplary web service layout provided for designing a business tool;

FIG. 7 shows schematic of a configuration to provide a wireless gateway at the client site using, (a) a captive web service enabled wireless router, and (b) a wireless router with a software enabled captive web service device;

FIG. 8 schematically shows a flow chart, outlining steps for a consumer at a client site to access and activate a business application offered on a mobile device;

FIGS. 9a and 9b show a sample mobile device screen showing a map highlighting business places registered with the vendor in a specified geographic region;

FIG. 10 represents a sample promotion offer screen shot;

FIG. 11 shows a sample of a web service provided for a consumer to set their social networking preferences;

FIG. 12 shows an exemplary web service provided for consumer satisfaction feedback; and

FIG. 13 shows an analytics web service screen shot provided by the vendor.

### DETAILED DESCRIPTION OF THE INVENTION

A broad framework of the invention will be described in reference with the drawing figures. For clarity of description, each drawing figure illustrates different aspects of the invention either alone or in suitable combinations with other aspects shown in other drawing figures. However, features shown and described separately are not precluded in other combinations or sub-combinations, unless stated otherwise. The embodiments shown here together provide a broad framework of the invention and may be practiced in parts or in different applicable combinations that may occur to those skilled in the art. The business method provided in this invention may be implemented using standard equipment widely used in the industry for networking stationary and/or mobile electronic devices (mobile devices) Although specific stationary or mobile devices are named to illustrate the principles, other equivalent devices having similar functionality are not precluded.

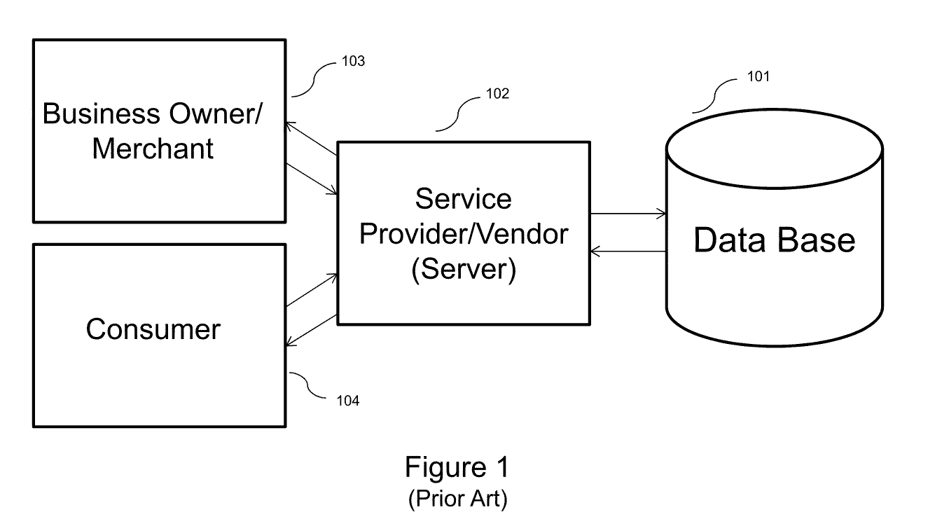

Referring now to FIG. 1, there it shows an arrangement of basic components of a network where the invention may be practiced. For the ease of description, a basic architecture quite common in the art is selected. Details of the architecture will not be described further. In the simplest form, the arrangement comprises a server (102) operated by a service provider (referred as a vendor hereinafter) to connect to a data storage medium (101) capable of storing data organized in one or more databases. The vendor provides access to the database to a business owner or (referred as a client hereinafter) (103) as well as to a consumer (104) via secured web services over communication links that may include wired links or more preferably, a wireless link. The client as well as the consumer connect to a Wide Area Network, the Internet or a cellular network in both directions (as shown by arrows), using a wireless access point located at the client site. Any standard wireless communication protocols that are well known in the art may be used for this purpose.

The server may include a single machine or multiple machines connected on the vendor site, or remotely. The server and the data storage device are in general equipped with data communication facilities for example, sending and receiving ports connected to one or more communication link. In general, the server is equipped to communicate with the data storage device in both directions as shown by arrows. More specifically, the vendor may upload data to the storage device as well as access/download data from the storage device. The vendor may own the server as well as the database or it may be a rented or shared in parts or in entirety.

The client site equipment may include preferably a stationary device such as a computer (desktop, laptop or a notebook computer) that has a processor, a local memory device and can be linked to Vendor's server over a wired or preferably, a wireless communication link. The client also requires a wireless access point for example a wireless router, providing wireless connectivity to and from the server as well as to mobile devices in the vicinity or within a certain pre-determined geographic region. All the hardware at the client site may be owned or rented by the client or provided by the vendor.

The consumer equipment is preferably a mobile device for example, a cell phone, a smart phone, a tablet or other portable electronic device having information transfer/exchange capability over a wireless communication link. The consumer connects to the Internet to access information over a wireless link using the wireless access point provided at the client site. As will be described shortly, the communication link may be any kind of broadband link including but not limited to a Digital Subscriber Line (DSL) enabled wireless router or a 3G or 4G cellular network.

The communication link may be in the form of a cable modem, a broadband wired link, an optical communication link, a wireless communication link, a satellite link or a suitable combination thereof, that are widely known in the art. In another form, the server(s) and the data base(s) may be physically located on the same site or may be connected remotely via a communication link. In yet another form, the vendor may prefer to use a ‘cloud’ based server and/or database. In yet another variation, the server and database are co-located. Other variations of physical equipment and/or communication links and protocols to implement the present invention may be apparent to those skilled in the art. All such variations, combinations and sub-combinations are included within the broad framework of this invention.

It is noted that the method of present invention is particularly suited for businesses that do not have access to a network, for example a broadband network and small businesses that include but are not limited to, independent business owner, specialty store, ethnic store, a home based business, religion and community service organizations, that do not have resources and/or expertise to develop business application(s) (Apps) on their own. In a basic implementation of the method the vendor provides to the client a platform to develop business application(s). More specifically, the vendor provides necessary hardware, software, and support services to provide a communication link to the vendor's server and/or to the database via a secure web service.

### Client Web Service:

The client uses vendor services to develop business application(s) for different purposes. The client may develop business application(s) that include but are not limited to collecting consumer feedback to generate consumer demographic and socio-economic information which in turn enable the client to customize advertisements, special promotional offers and/or discounts. The client may also access and utilize vendor services to promote, customize and expand the business to one or more consumer groups based on demography, age, gender and so forth. For example, a specialty grocery store (client) may develop and use a business application to advertise to a specific demographic group.

The advertisement or promotion offer is then disseminated to consumers on mobile devices upon entering a certain geographic region of the client by connecting to the wireless network using a wireless hot-spot set up at the client site. The business application may use any position locator Apps that are widely available to determine a mobile device position with respect to the client location. More specifically, a consumer in the vicinity after providing a response to a consumer survey can view, redeem, forward or provide feedback for the promotional offer by launching an App using the Internet browser, a preloaded App on the mobile device, or through a social media network.

A key aspect of the invention is that the vendor platform offers the client full control of design and development of different business application(s). For example, the client has control over determining the type, design (visual/text), format, begin and end dates (duration), extension, expansion of the offer to other items, to include special interest group(s) of people, etc. Moreover, the client has complete freedom to alter or add other business application tools at any time they wish, within a short duration or in real time while the consumer is present at the client site.

For example, a client may promote sale of a product or service tweeting the same to consumers present at the client site in response to consumers' activity such as, a consumer providing a feedback about a particular product or service to another consumer present at the client site thereby promoting sale of a particular product or service offered by the client. Furthermore, the client may promote a product or a service using an online auction where consumers participate using their mobile devices. The business method is well suited to adapt and modify a business application within in a short duration, or even in real time. Those skilled in the art may be able to appreciate that this aspect of the business method has wide applicability in the retail marketing sector.

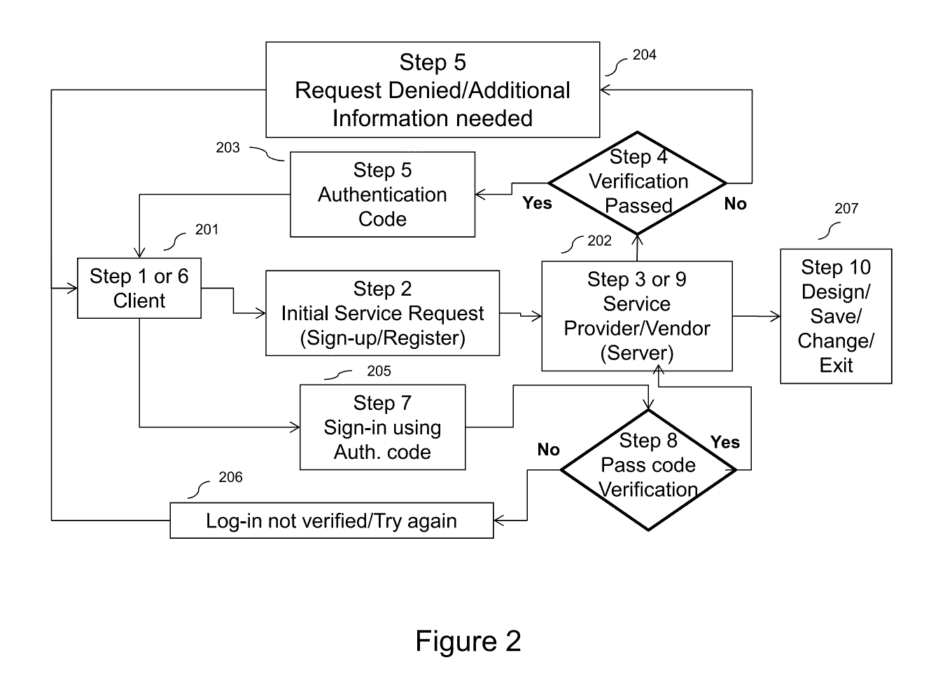

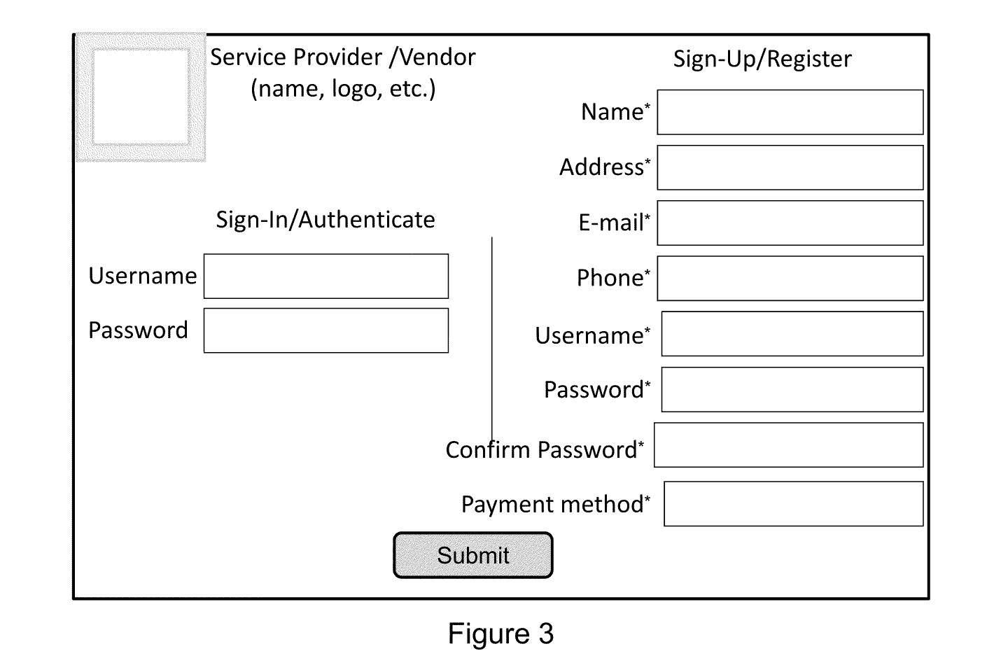

Referring now to FIGS. 2 and 3, the vendor offers services using a secured web service screen, an example of which is shown in FIG. 3 where a client registers/signs-up or signs-in according to a procedure schematically shown in a flow diagram shown in FIG. 2. Referring simultaneously to FIGS. 2 and 3, the method comprises following steps—an initial service request is sent by the client (201) to the vendor (202) to register for accessing services offered (step 1). To register for the first time (Step 2), the client enters information about the business in the fields shown on the right hand side of the exemplary screen shown in FIG. 3 (Step 3).

Once a service request is submitted, the vendor verifies the information provided by the client (Step 4). The vendor sends an e-mail message (Step 5), the content of which is determined by the result of the verification process. For example, if the information is correct, an Authorization Code (or code hereinafter) (203) is sent, or an error message (204) is sent to the client. The messages shown here are only exemplary and should not be construed as limiting. The vendor may send other messages depending upon the nature of the request and results of the verification process. Upon receiving an error message, the client may choose to retry following the instruction provided by the vendor (Step 6)

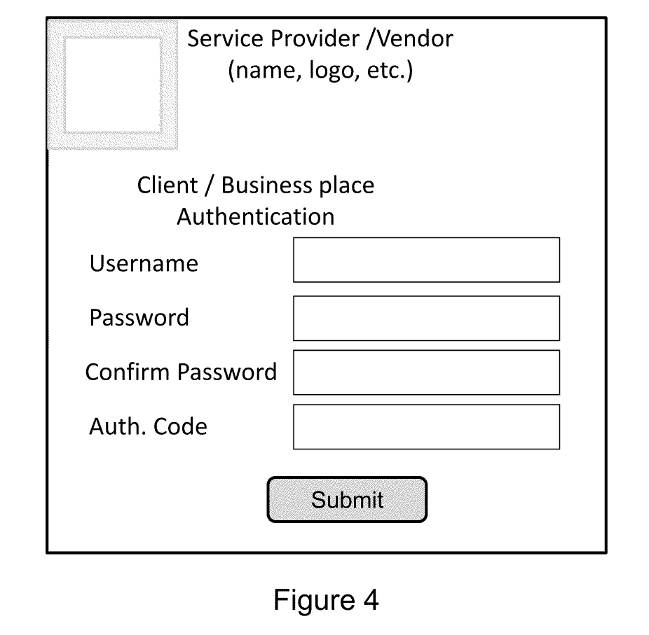

Upon receiving the code, the client signs-in at any time using the code (Step 7) using a web service screen a sample of which is shown in FIG. 4. The vendor verifies the code (Step 8) and either approves for login to the server or sends an error message (205) depending upon the results of the verification process. Once approved for login, the client is authorized to login (Step 9) and use the services offered by the vendor to design business application(s) (Step 10). To begin a new session the client needs to log-in using the left hand side of the web service screen shown in the in FIG. 3, and/or with the code using the web service screen shown in FIG. 4. It can be appreciated that the layouts shown in FIGS. 3 and 4 are merely examples and other web service screen designs that may be more suitable to any other vendor or for any other kind of business application tool, may work equally well.

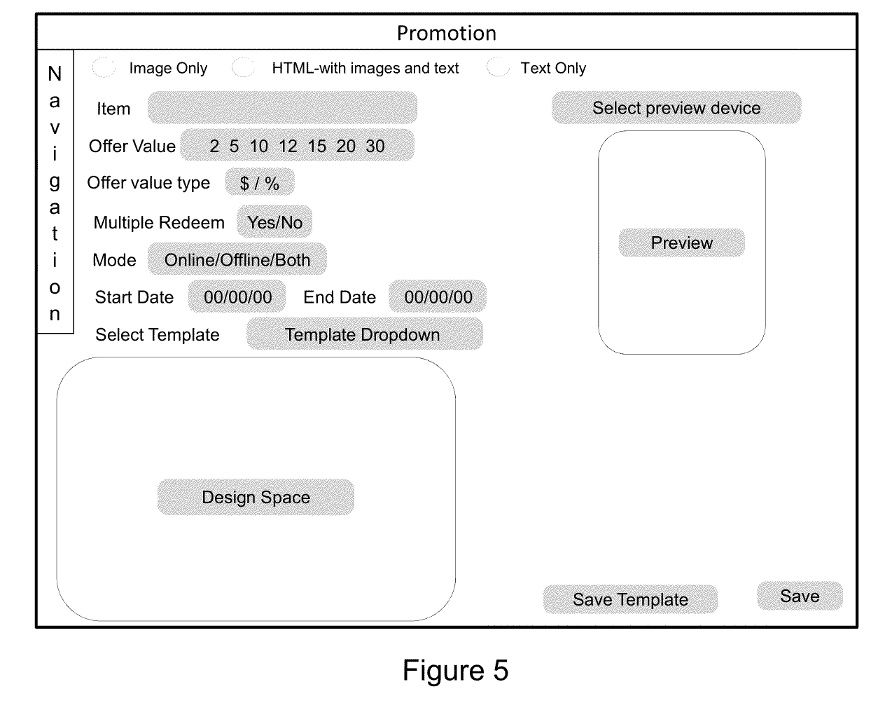

Referring to FIG. 5, there it shows a sample template provided by the vendor to create a business application. In this particular example, a template is provided to create a Promotion offer by the client, or a representative authorized by the client (creator). The menu options are self-explanatory and are selected using buttons or from a ‘drop down’ list. A client (creator) fills fields shown in the screen according to the business application being created which in this example is shown to be a Promotion offer. The client is provided with predesigned templates or may create own templates in the design space provided. Templates created by the client may be saved for future use and are added to the drop down list.

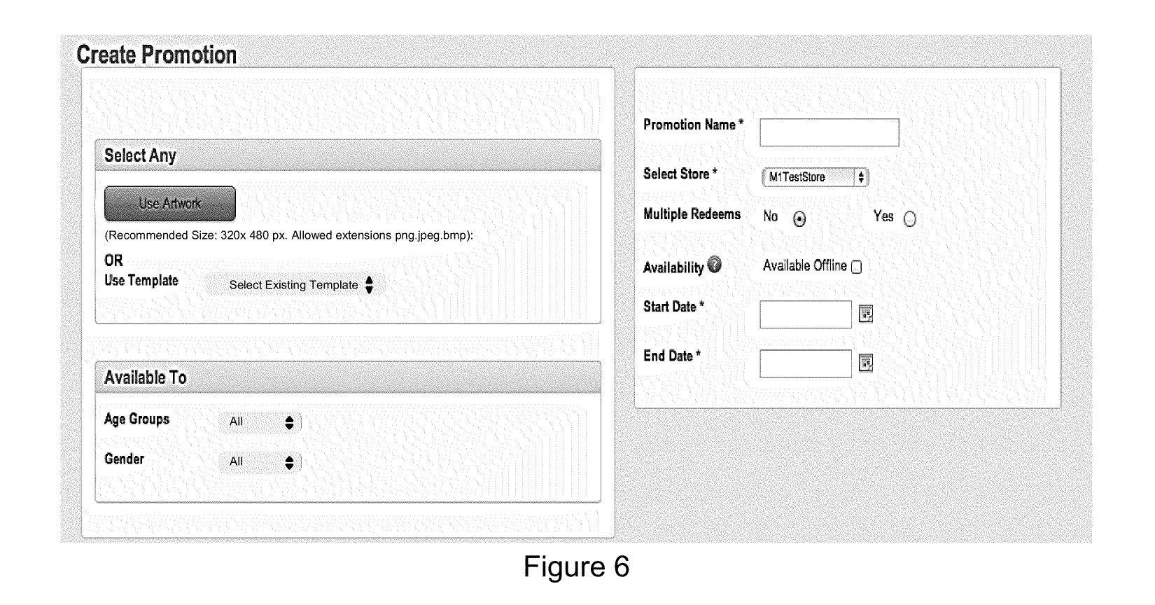

The design template also provides options to preview a business application while it is being developed. Sample screens for a variety of mobile devices may be selected from a drop-down list of devices, such that the client has options to tailor the visuals to different types of mobile devices. Another example of a design template using a drop-down list available for creating business application is shown in FIG. 6. The design template offers more flexibility for combining visuals that are preferred by the client and using standard menu options provided by the vendor.

A client may register for more than one businesses in different locations and the sample template shown in FIG. 6 offers a choice for selecting any of those businesses for designing or modifying business applications. It should be noted that the design templates shown here are only for illustrative purposes to explain the concepts. It is possible to create other design templates from a range of possibilities for example, images, photos, graphics, drawings, video clips, film clips, text, audio clips and combinations thereof, depending upon the type of business application being created.

### Consumer Web Service:

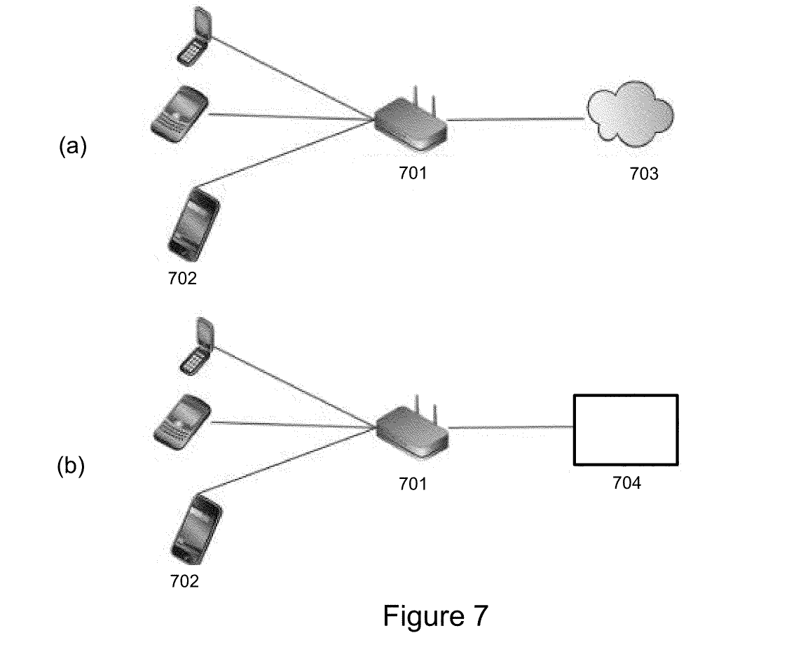

One aspect of the business method is to provide business application(s) developed by the client directly to consumers. The business application offering a Promotion deal described in reference with the client web service in the previous section is selected for the purpose of illustration. However, the method may be adapted for other business application without digressing from the broad framework of the invention Examples of network configurations shown in FIGS. 7a and 7b may be used to connect a mobile device to a Wide Area Network (WAN) for example, the Internet or to a cellular network at the client location.

In the configuration shown in FIG. 7a a wireless access point is provided using a wireless router 701, preferably a DSL enabled wireless router. The captive web service enabled wireless router is connected to the Internet (703) and acts like a wireless hot spot. Upon entering a geographic region where a client is located, a consumer using a mobile device 702 (only one labeled for clarity) connects to the Internet via the wireless router port at the client site. In an alternative arrangement shown in FIG. 7b, the wireless access point is provided using an ordinary wireless router 701. The router is connected to a separate device 704 (for example, one sold under the Trademark name Raspberry Pi™) configured with an open source captive web service software (for example, one sold under the Trademark name Coovachilli™) to connect the consumer mobile device over a cellular network. The captive web service device in this arrangement hosts a radius server authenticator. One advantage of this alternative arrangement shown in FIG. 7b is that a client located in a remote area without having access to broadband connectivity to the Internet, may be able to offer business application(s) to consumers using cellular network (for example 3G or 4G cellular network).

In practice, when consumers enter the client site or a pre-determined geographic region in the vicinity of it, the consumers' mobile devices connect to the Internet using the wireless access point provided at the client site. Upon establishing a connection for the first time at the client site, the consumers are requested to provide a response/feedback to a consumer survey. In one embodiment of the invention, and in particular when the Internet connection is provided using a DSL enabled wireless router as shown in FIG. 7a, a feedback to the survey may be is followed by a request to log into the consumers' social networking site. A consumer profile is generated using the consumer survey feedback or accessed from the consumers' social networking site.

Upon providing the feedback to the consumer survey followed by logging in to a social network site, the business application is launched over a web browser. The consumers are provided an option to download the business application (App) that is available from the App Store or continue to use the browser based business application to check the Promotion offer(s) available from the client registered with the vendor providing the web service. If the customer chooses to download the App, then in a subsequent visit(s) the downloaded App is launched automatically requesting the consumers to provide a feedback to the consumer survey and additionally view Promotion offer(s) from the client.

In an alternative embodiment, and in particular at a client site without having a broadband connectivity to a WAN or the Internet, (for example, in the configuration shown in FIG. 7b) the consumer is requested to provide response to a consumer survey on a webpage. The survey feedback then generates a consumer profile. Upon providing the feedback to the customer survey, the consumer is sent a message on a webpage that an App is available to be downloaded over the consumers' cellular phone, for example using a 3G or 4G cellular networks. If the consumer selects this option, an App is downloaded over the mobile device's data plan, and the consumer can view current Promotion offer(s) provided by the client.

In subsequent visits to the client site, the App on the mobile device launches automatically to view the Promotion offer(s) upon providing a feedback to the customer survey. Depending upon the type of wireless access point set up at a client site (DSL or non-DSL types shown in FIGS. 7a and 7b, respectively), the consumer survey webpage may have a different design and layout. Those skilled in the art will be able to recognize that the embodiment of the invention shown in FIG. 7b is particularly suited for remote areas having poor or no broadband infrastructure.

One important objective of the invention is to provide the client an access to information about consumers so as to understand the consumer base. In one aspect, the vendor web services offers the client a platform to analyze data (analytics) and in particular offer analytics pertaining to consumer profile information including but not limited to, demographic, socio-economic and product/service/networking preference from the feedback consumers provide in response to the consumer survey upon signing-up or signing-in.

Having access to consumer information is particularly important and utilitarian for clients having small business to customize the business applications according to the consumer base. In another aspect, the client has flexibility to modify or customize a business application(s) to suit a particular group(s) of consumers visiting a client site in a short time, or even in real time, as has been described earlier in reference with the discussion in the Client Web Service section. Those and other advantages of the invention may be appreciated by those skilled in the art.

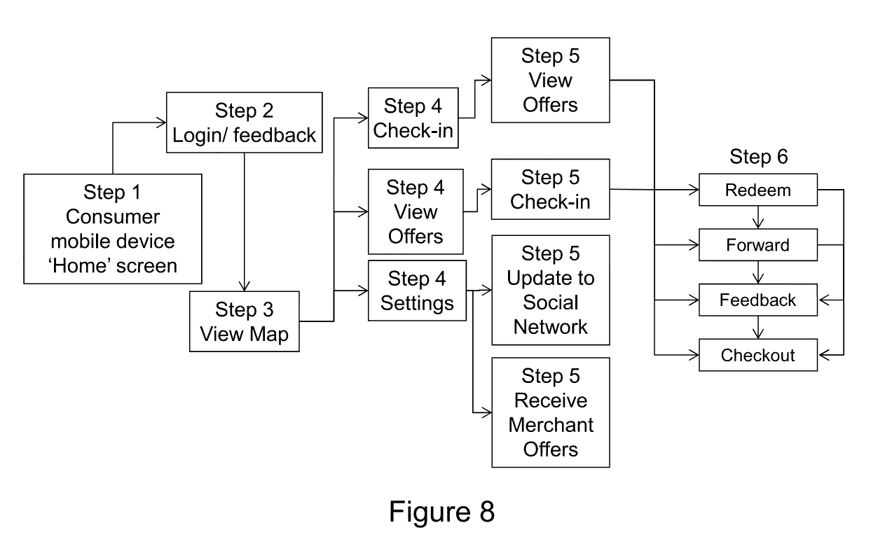

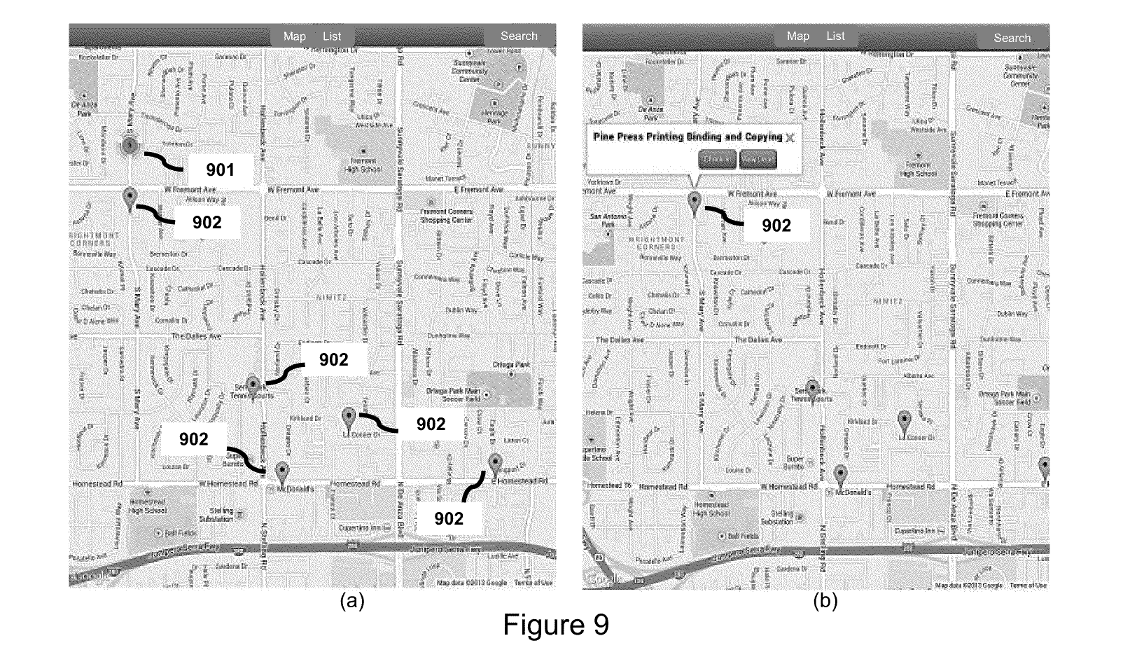

FIG. 8 schematically shows a flow chart that outlines the steps to utilize a business application. To illustrate the method, the business application for a Promotion offer described earlier, is selected. The consumer may view the Promotion offer(s) either on a web browser or by launching the App on their mobile devices (Step 1) as described in the previous section. Upon launching the App, a consumer is provided a ‘map’ view to see all the clients (business and service places) registered with the vendor and located within the same geographic region (Step 2). Furthermore, the consumer has an option to view all the clients co-located in the same geographic region in a ‘map’ or a ‘list’ view. For example, referring now to FIG. 9a, there it shows a typical ‘map’ view screen as seen on a consumer's mobile device. In particular, the spot labeled 901 on the map represents the consumer's location with respect to clients that are registered with the vendor shown with icons labeled 902. In particular, a consumer is able to view all the Apps offered by one or more clients in that specific geographic area by clicking on the sites. A sample screen shot shown in FIG. 9b depicts an expanded view when a consumer clicks at a particular location on the map. Alternatively, a consumer may select a particular client site using a drop down list in the ‘list’ view and locate it on the map to view Promotion offer.

Referring back to FIG. 8, there it outlines the options and procedure to view and avail any particular Promotion offer(s). More specifically, the customer is provided with different options to check-in, view offers or activate settings to update (status) on a social network site (Step 3 options). While the options provided in Step 3 will be described separately in a particular order, it is not necessary that the options be selected in that specific order. In one implementation the consumer can first opt to check-in at a client site and view all the offers in a list form and select one or more options (Step 4). If the consumer selects a particular offer, it is displayed on the mobile device screen.

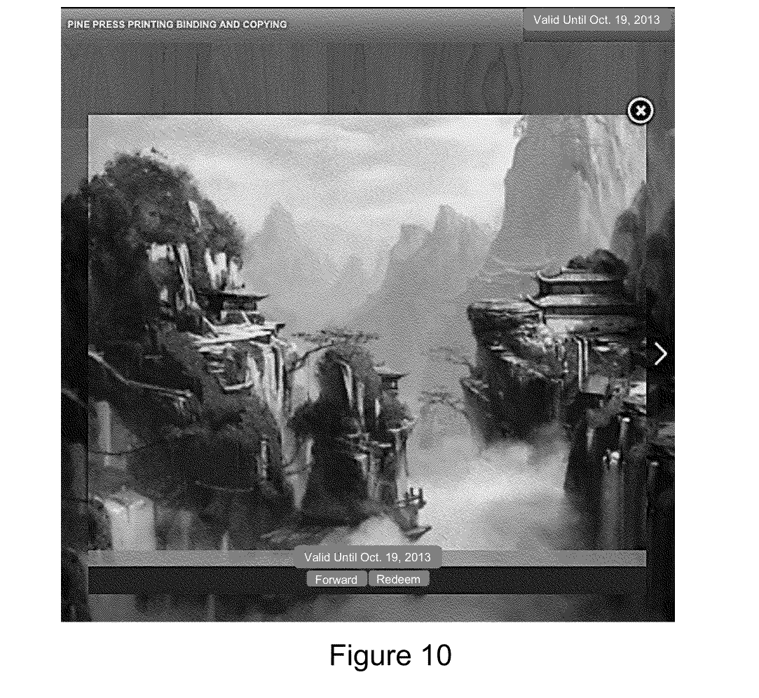

For example, a screen shot of a print shop offer is schematically shown in FIG. 10. This graphic is only for illustrative purpose and should not be construed as limiting. After selecting a particular offer, the consumer is provided with various options to select from (in Step 5, FIG. 8). In particular, a consumer may redeem the offer, share/forward the offer to a friend on a social media website, provide a feedback to the client, and checkout. It is noted that although the options are indicated in this particular order for illustrative purposes, there is no particular order in which the options are actually exercised.

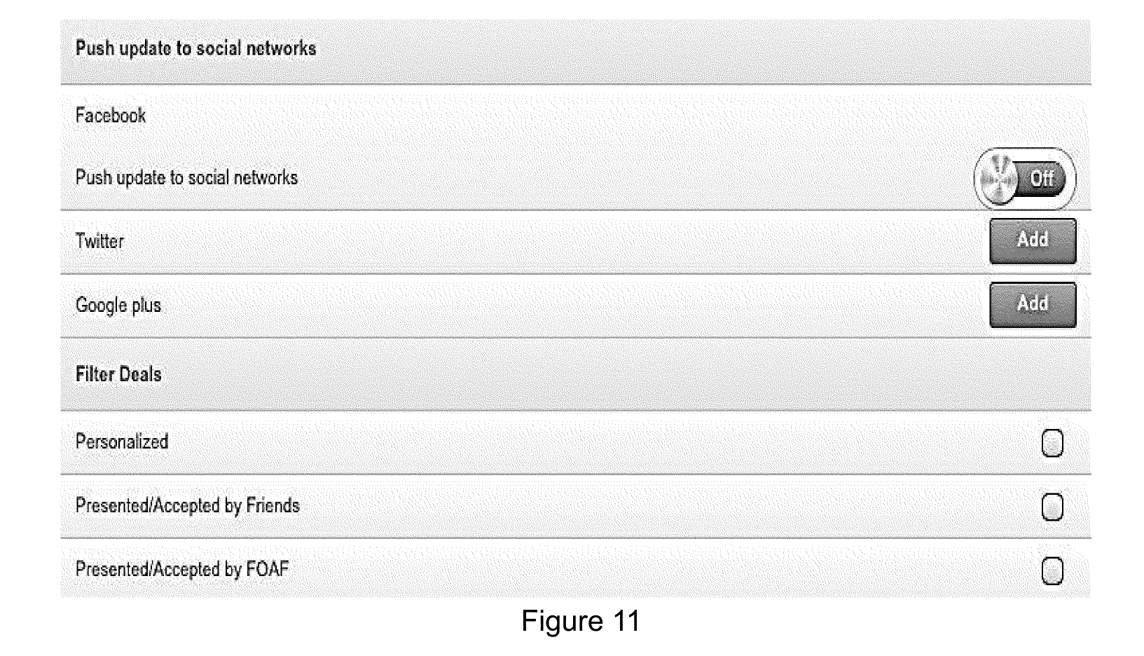

Referring back to the flow chart shown in FIG. 8, an alternative way to implement the invention is to follow a different path in Step 3. More specifically, the consumer may first view all the offers from the clients shown in the map in a list form, and select to check-in with a particular client (Step 4). The consumer follows the same steps as in Step 5 described earlier to avail the offer. In yet another implementation, the consumer is provided with an option to go to the setting page in Step 4, and share available offers with a friend on a social media website. FIG. 11 shows an exemplary web service provided by the vendor to activate settings on a consumer's mobile device. The web service also provides the consumer an option to accept offers from a friend or a friend of a friend (FOAF) using a social media website and redeem an offer using the steps described in reference with the flowchart shown in FIG. 8. Different options described here may be exercised either alone, or in different combinations in any preferred order.

### Data Analysis (Analytics):

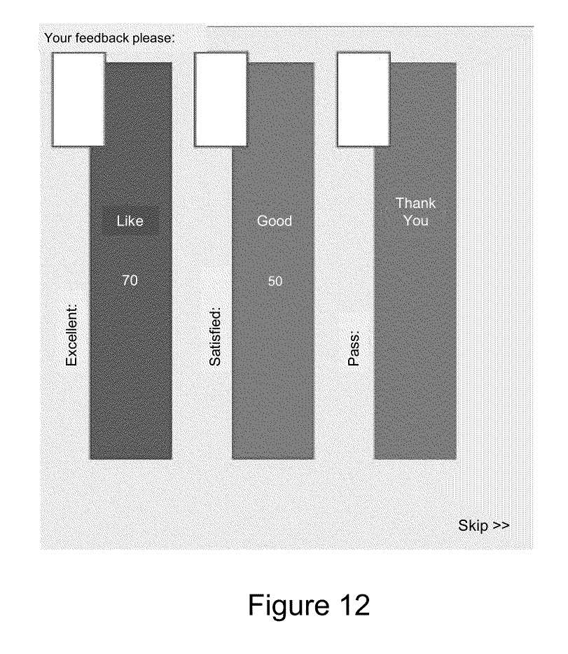

One important objective of the invention is to provide the client with a flexible platform to access consumer profile information and consumer satisfaction feedback for sales and marketing analysis. In one aspect of the invention, the vendor services includes a web service for consumers to provide consumer satisfaction feedback for a particular business application. Referring back to the example of a Promotion offer business application, consumers before checking out may provide consumer satisfaction feedback for a particular promotion offer on a template provided by the vendor. One exemplary web service screen for this purpose is shown in FIG. 12. In this particular example, the consumer is provided three options shown as three bars ‘Excellent’, ‘Satisfied’ and ‘Pass’ to rate their experience. The consumer provides feedback by checking one of the three options. The consumer may defer to provide their feedback by skipping the page (skip the page option shown in the bottom right hand corner).

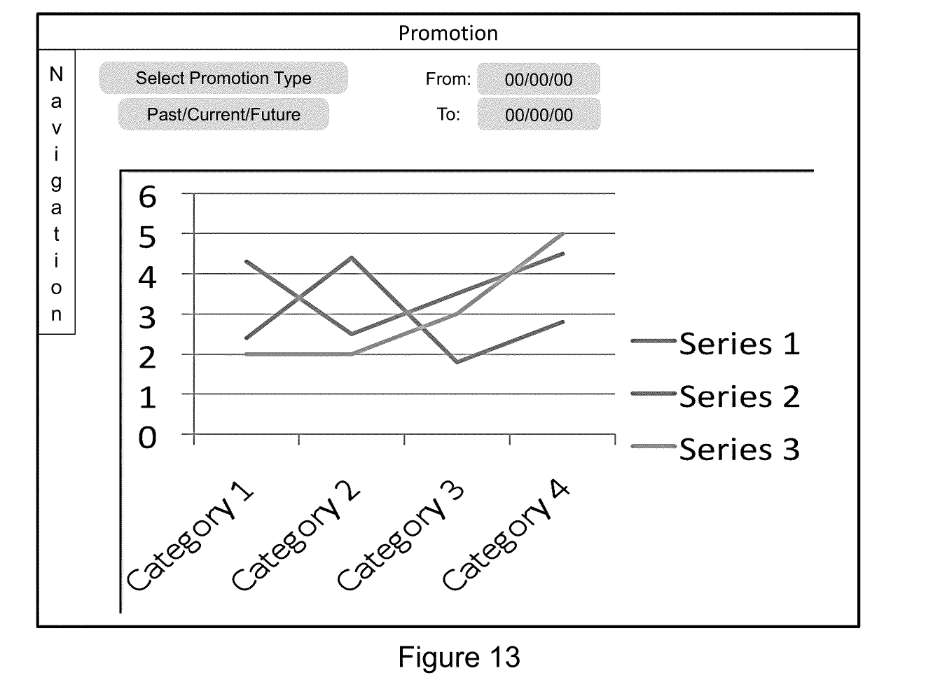

In a different aspect of the invention, the vendor offers premium services to collect and/or analyze the data a client obtained from the feedback to the consumer survey. For example, from the anonymized consumer information such as, demographic data, gender, age, shopping preference and habits about the customer base, the vendor/client may use consumers' demographic information to customize a business application for a particular group or groups of consumers. In another aspect of the invention the vendor may provide consumer satisfaction feedback data obtained from a survey similar to the one described with reference to FIG. 12. In yet different aspect of the invention, the vendor may compile data for the client from different surveys to provide an overall perspective about the client's business. For example, a client is offered a platform to analyze multiple consumer satisfaction feedback data for comparison as shown in FIG. 13. More specifically, a client may be able to compare response to various Promotion offer(s) for different categories of consumers, for different periods when a particular offer was provided, and so forth. Those skilled in the art will recognize that information obtained from consumers may be analyzed in different ways to customize different business applications. It should be noted that the web service shown here for analytics is just one example applicable for the business application related to the Promotion offer example selected for discussion. A client may develop other analysis format depending upon the business application.

The business application example described here is merely illustrative of the business method provided according to this invention. It is noted that the different aspects of the invention when applied either alone or in combination, provide a client with a capability to design, control and monitor the business application using a single platform for business development. It will be apparent to those skilled in the art that different aspects described using a specific example of developing business tools for commercial application to illustrate the broad principles of the business method may be extended to other areas either as a whole or in parts. For example, the business method may be extended to organizations engaged in providing community services to reach out to a wider customer base, better organization and utilization of resources. While the invention is described using a few examples, the full scope of the invention is determined by the claims.

What is claimed is:

1. A business method comprising the steps of:
a vendor providing a wireless access point at a client site, said wireless access point for connecting to a server;
the vendor providing one or more web service to the client for developing at least one business application;
the client disseminating said at least one business application to at least one consumer on a mobile device over a wireless network when the mobile device connects to the wireless network via the wireless access point provided at the client site; and
the at least one consumer receiving said business application on the mobile device.

2. The business method as in claim 1, wherein said steps of disseminating and receiving said business application is preceded by a step of providing a feedback to a consumer survey by the at least one consumer.

3. The business method as in claim 2, wherein the data from the feedback generates consumer information that is one selected from a group consisting of demographic information, socio-economic information, product, spending and service preference information, social networking information, and a combination thereof.

4. The business method as in claim 3 including a further step of customizing said business application in response to consumer analytics, wherein said customization may be performed while the consumer is present at the client site, in a short duration or in real time.

5. The business method as in claim 1, wherein said step is preceded by a step of the at least one customer providing a feedback to the customer survey.

6. The business method as in claim 1, wherein said step of connecting to the server is preceded by a step of client registering with the vendor, facilitated through a secure web service provided by the vendor.

7. The business method as in claim 1, wherein said step of connecting to the server is subjected to a verification process for providing an authorization code to the client for secure login to the server.

8. The business method as in claim 1, wherein the step of developing at least one business application is facilitated by providing a vendor web service including one or more predesigned templates or a template designed by the client using design options provided by the vendor.

9. The business method as in claim 1, wherein the step of developing at least one business application is followed by a step of previewing at least one business application for one or more mobile devices selected from a predetermined list of mobile devices.

10. The business method as in claim 1, wherein the at least one business application is one selected from a group consisting of an advertisement, a promotion offer and a combination thereof.

11. The business method as in claim 1, wherein the step of receiving said business application tool is facilitated by downloading an App on the mobile device.

12. The business method as in claim 1, wherein said step of receiving is followed by further steps of:
viewing of contents delivered by the business application tool; and
taking further actions including the steps that is one selected from a group consisting of checking-in, redeeming, setting social media preferences, forwarding the business application tool, sharing the business application tool, providing customer feedback, checking-out and a combination thereof.

13. The business method as in claim 1, wherein providing a wireless access point is facilitated by providing a captive web service enabled wireless router at the client site, such that the mobile device connects to the Internet over a Digital Subscriber Line.

14. The business method as in claim 1, wherein providing a wireless access point is facilitated by providing a wireless router in combination with a device enabled with an open source captive web service at the client site, such that the mobile device connects to a cellular network that is one selected from a group consisting of a 3G network and a 4G network.

15. The business method as in claim 1 including further steps of providing premium service to the client on a vendor web service, wherein said premium services is one selected from a group consisting of consumer analytics information, consumer feedback for business application, data analysis and a combination thereof.

16. A business method comprising the steps of:
a vendor providing services to the client for developing an advertisement for a business promotion offer;
the vendor providing a wireless access point at a client site, said wireless access point for connecting to a server over a wireless network
the client disseminating the business promotion offer to one or more consumers on respective mobile devices over a wireless network that is necessarily accessed using the wireless access point at the client site; and
the one or more consumers receiving the business promotion offer on the respective mobile devices.

17. The business method as in claim 16, wherein said step of connecting to the server includes the steps of:
the vendor providing a secure web service to the client for;
registering, with the vendor by providing client information,
receiving, an authorization code to sign-in,
connecting, to the server to receive services for developing the promotion offer by selecting a vendor provided template or by designing own template,
previewing, the promotion offer for mobile devices selected from a predetermined list prior to disseminating the same to the one or more consumers.

18. The business method as in claim 16, wherein said disseminating step is preceded by a further step of providing feedback in response to a customer survey by said one or more consumers for generating consumer profiles, and customizing the promotion offer in response to consumer profiles.

19. The business method as in claim 16, wherein said step of receiving is followed by one or more steps that is one selected from a group consisting of, providing consumer survey feedback, checking-in with the client, viewing contents of the promotion offer, redeeming a promotion offer, setting social media preferences, forwarding and sharing promotion offer using social networking site, checking out, and a combination thereof.

20. The business method as in claim 16 including further steps of providing premium services to the client on a vendor web service, wherein said premium services is one selected from a group consisting of consumer information analytics, consumer satisfaction feedback, and a combination thereof.
